(19) United States
(12) Patent Application Publication
(10) Pub. No.: US 2026/0119287 A1
(43) Pub. Date: Apr. 30, 2026

(54) MANAGING LIFECYCLE INFORMATION, SUCH AS AUTOMATED BULK BRANCHING, METHOD, AND SYSTEM

(71) Applicants: Siemens Industry Software Inc., Plano, TX (US); Siemens Industry Software, s.r.o., Praha (CZ)

(72) Inventors: Ondrej Chylik, Praha (CZ); Adrian Whitfield, Plano, TX (US)

(21) Appl. No.: 18/925,578

(22) Filed: Oct. 24, 2024

(51) Int. Cl. G06F 9/54

(52) U.S. Cl. CPC G06F 9/543; G06F 2209/545

(57) ABSTRACT

For an improved management of lifecycle information, such as automated bulk branching, a computer-implemented method includes: providing a plurality of sets of lifecycle information; receiving first user input indicative of copying at least one first subset of the plurality of sets using copy options; generating computer instructions for copying one or more sets of lifecycle information using the copy options; displaying a user interface (UI) element in a lifecycle information management UI to a user, wherein the UI element is indicative of a use of the copy options according to the computer instructions; receiving second user input indicative of a selection of the UI element with respect to at least one second subset of the plurality of sets; and storing a copy of the respective second subset using the computer instructions.

### TECHNICAL FIELD

The present disclosure is directed, in general, to lifecycle information management systems, such as product lifecycle management (PLM) systems and application lifecycle management (ALM) systems, (e.g., for software), that are used to create, use, and manage data for products including software and artifacts and other items. The mentioned systems are collectively referred to herein as product systems, wherein PLM and ALM are used interchangeably.

### BACKGROUND

Product systems may include large amounts of stored lifecycle information. Currently, there exist product systems and solutions that support managing lifecycle information. Such product systems may benefit from improvements.

### SUMMARY

Variously disclosed embodiments include methods and computer systems that may be used to facilitate managing lifecycle information, such as automated bulk branching.

According to a first aspect of the disclosure, a computer-implemented method of managing lifecycle information may include: providing a plurality of sets of lifecycle information; receiving first user input indicative of copying at least one first subset of the plurality of sets using copy options; generating computer instructions for copying one or more sets of lifecycle information using the copy options; displaying a user interface (UI) element in a lifecycle information management UI to a user, wherein the UI element is indicative of a use of the copy options according to the computer instructions; receiving second user input indicative of a selection of the UI element with respect to at least one second subset of the plurality of sets; and storing a copy of the respective second subset using the computer instructions.

According to a second aspect of the disclosure, a computer system may be arranged and configured to execute the acts of this computer-implemented method according to the first aspect.

According to a third aspect, a computer program product may include computer program code that, when executed by the computer system according to the second aspect, causes the computer system to carry out the method according to the first aspect.

According to a fourth aspect, a computer-readable medium may include the computer program product according to the third aspect. By way of example, the described computer-readable medium may be non-transitory and may further be a software component on a storage device.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, various definitions for certain words and phrases are provided throughout this patent document and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 depicts a functional block diagram of an example system that facilitates managing lifecycle information, such as automated bulk branching, in a product system.

FIG. 2 depicts two aspects relating to the facilitated management of lifecycle information, such as automated bulk branching, in a product system.

FIGS. 3-5 depict an example lifecycle information management UI relating to the facilitated management of lifecycle information, such as automated bulk branching, in a product system.

FIG. 6 depicts a flow diagram of an example methodology that facilitates managing lifecycle information, such as automated bulk branching, in a product system.

FIG. 7 depicts a block diagram of a data processing system in which an embodiment may be implemented.

### DETAILED DESCRIPTION

Various technologies that pertain to systems and methods for managing lifecycle information, such as automated bulk branching, in a product system are now described with reference to the drawings, where like reference numerals represent like elements throughout. The drawings discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present patent document are now described with reference to exemplary non-limiting embodiments.

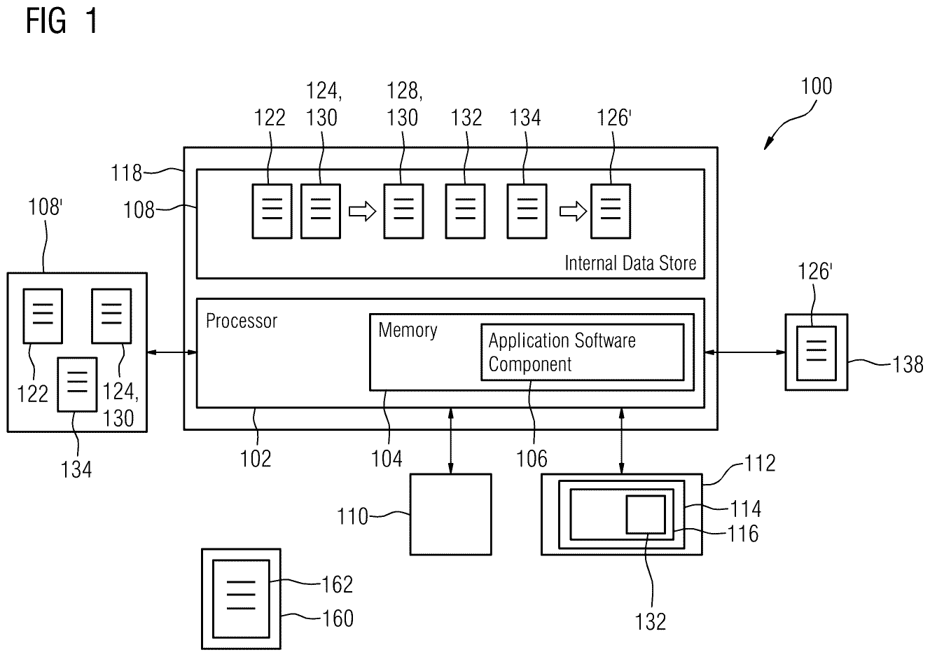

With reference to FIG. 1, a functional block diagram of a first example computer system or data processing system 100 is depicted that facilitates managing lifecycle information, such as automated bulk branching, in a product system 100. The processing system 100 may include a product lifecycle management (PLM) system 118 that may include at least one processor 102 configured to execute at least one application software component 106 from a memory 104 accessed by the processor 102. The application software component 106 may be configured (i.e., programmed) to cause the processor 102 to carry out various acts and functions described herein. For example, the described application software component 106 may include and/or correspond to one or more components of an application for managing lifecycle information, such as automated bulk branching, in a product system 100, wherein the application software component 106 may be configured to generate and store product data in a data store 108 such as a database.

The PLM system 118 may allow for the management of lifecycle information, e.g., of a physical or software product, by providing corresponding functionalities to a user and by creating, amending, or managing corresponding lifecycle information. Herein, the lifecycle information may include a model artifact characterizing lifecycle properties of the physical or software product. By way of example, the lifecycle information or the model artifact may relate to or include the conception, requirements, uses cases, test cases, issues, design, realization, and/or service information of the physical or software product. In further examples, the lifecycle information or the model artifact may include data records representing/storing data corresponding to parts, tools, documents, process descriptions, templates, materials, requirements specifications, further software products, or software applications relating to the physical or software product. By way of example, the lifecycle information may include a plurality of sets 122 of lifecycle information, wherein large quantities of such sets 122 of lifecycle information may be understood as bulk.

By way of example, the product lifecycle management system 118 may be cloud-based, internet-based, and/or be operated by a provider providing support for managing lifecycle information, such as automated bulk branching. In some examples, the user may be located close to the PLM system 118 or remote to PLM system 118, e.g., anywhere else, e.g., using a mobile device for connecting to the PLM system 118, e.g., via the internet, wherein the mobile device may include an input device 110 and a display device 112. In some examples, the PLM system 118 may be installed and run on a user's device, such as a computer, laptop, pad, on-premises computing facility, or the like.

Examples of product systems that may be configured to include the management of lifecycle information, such as automated bulk branching features described herein, may include the Active Workspace features of Teamcenter, an application produced by Siemens Industry Software Inc., of Plano, Texas, USA or Polarion ALM, an application produced by Siemens Industry Software GmbH, of Zurich, Switzerland. However, the systems and methods described herein may be used in other product systems (e.g., PLM, product data management (PDM), ALM systems) and/or any other type of system that generates and stores product data in a database. Also, examples of databases that may be used as one or more data stores described herein include database server applications such as Oracle, Microsoft SQL Server, or any other type of data store that is operative to store data records.

Managing lifecycle information, such as automated bulk branching, may be a challenging and time-consuming process which may require highly skilled developers with many years of training and expert domain knowledge. For example, when developing a new product or new product features, certain developers, and product owners may work parallelly and simultaneously on product requirements and how the product requirements may be implemented in the product, wherein the corresponding requirements information may be understood to be artifact information. To allow for such parallel and simultaneous collaboration, branch documents may be created from a master artifact information document, wherein the branch documents may later be merged again to obtain one final master document. Branching and merging may be particularly challenging for large amounts of artifact information, hence, for bulk artifact information.

To enable the enhanced management of lifecycle information, such as automated bulk branching, the described product system or processing system 100 may include at least one input device 110 and at least one display device 112 (such as a display screen). The described processor 102 may be configured to generate a graphical user interface (GUI) 114 through the display device 112. Such a GUI 114 may include GUI elements such as buttons, links, search boxes, lists, text boxes, images, scroll bars usable by a user to provide inputs through the input device 110 that cause managing lifecycle information, such as automated bulk branching. By way of example, the GUI 114 may include a product lifecycle management (UI) 116 provided to a user.

In an example embodiment, the application software component 106 and/or the processor 102 may be configured to provide a plurality of sets 122 of lifecycle information.

The plurality of sets 122 of lifecycle information may be developed by one or more users of the PLM system 118 during the development of a new physical or software product, wherein the plurality of sets 122 may describe or characterize different aspects of the physical or software product, e.g., including requirements to be complied with by the physical or software product. The plurality of sets 122 may be provided and stored in the datastore 108 of the PLM system 118 and, in some examples, may be provided by another datastore 108′ to the PLM system 118, e.g., via an application programming interface (API).

In some examples, the application software component 106 and/or the processor 102 may further be configured to receive first user input 124 indicative of copying at least one first subset 126 of the plurality of sets 122 using copy options 130.

To manage the lifecycle information, the user of the PLM system 118 may provide the first user input 124, e.g., by selecting available copy options 130 for copying the respective first subset 126. The user may indicate the selection, e.g., by interacting with the PLM UI 116, wherein available copy options 130 may be displayed to the user via the PLM UI 116. Some exemplary copy options 130 are discussed in more detail below. Herein, the respective first subset 126 may include only a part and not all of the plurality of sets 122. In further examples, the user of the PLM system 118 may provide the first user input 124 in natural language, e.g., in text form using a keyboard as the input device 110 and using an input text box of the PLM UI 116, wherein oral input may also be possible, e.g. using a microphone as the input device 110.

By way of example, the first user input 124 may indicate which of the plurality of sets 122 are of interest to the user and accordingly form the respective first subset 126. Further, the first user input 124 may indicate one or more copy options 130 to be used for copying the respective first subset 126. In some examples, the respective copy option 130 may contribute to identify the respective first subset 126 among the plurality of sets 122. In further examples, the respective copy option 130 may indicate if or how the respective first subset 126 may be amended during the copy process before it is stored at some target location 138. In yet other examples, the respective copy option 130 may indicate the mentioned target location 138 to which the respective first subset 126 is to be copied.

In some examples, copying a given set 122 may mean creating a duplicate of the given set 122. By way of example, the created duplicate of the given set 122 may be different from the original given set 122 since the copy options 130 may imply making certain amendments to the original given set 122 to obtain the copied version of the given set 122. Such amendments are discussed in more detail below.

By way of example, the application software component 106 and/or the processor 102 may further be configured to generate computer instructions 128 for copying one or more sets 122 of lifecycle information using the copy options 130.

By way of example, the respective computer instruction 128 may be understood as an element of an executable computer program or as a representation of an element of an executable computer program. In the context of the present disclosure, the computer instructions 128 may include a set of instructions, which may be interpreted and executed by the processor 102 or the PLM system 118 and by which the processor 102 or the PLM system 118 may copy a respective set 122, e.g., from one data storage location to another data storage location. By way of example, respective computer instruction 128 may include a JavaScript which may be used in widgets to open a pre-configured bulk branch dialog in the PLM UI 116 with artifact information documents 148 or sets 122 for branching, thus saving time and effort.

In some examples, the copy options 130 provided by the user through the first user input 124 may be used to generate the computer instructions 128, e.g., such that the copy options 130 provided by the user in the context of the desired copy of the respective first subset 126 may be included or be reflected by the computer instructions 128. In some examples, the generated computer instructions 128 may use or implement the same copy options 130, which were initially provided in the context of copying the respective first subset 126, for copying a respective set 122 of artifact information, wherein this respective set 122 may be copied later or independently from the initially intended copy of the respective first subset 126.

In further examples, the generated computer instructions 128 may use or implement the copy options 130 to copy the respective first subset 126 according to the received first user input 124.

In some examples, the application software component 106 and/or the processor 102 may further be configured to display a user interface (UI) element 132 in a product lifecycle management UI 116 to a user, wherein the UI element 132 is indicative of a use of the copy options 130 according to the computer instructions 128.

The UI element 132 may include an element of interaction, such as a button, including a radio button, a check box, a toggle button, a switch, or the like. In some examples, the UI element 132 may include a slider, a spinner, a drop-down list, an icon, or the like. By way of example, a selection or activation of the UI element 132 by the user of the PLM system 118 may trigger the PLM system 118 to perform a certain task or activity. In other words, e.g., the user clicking upon the UI element 132 may trigger the PLM system 118 to perform an action, such as executing the computer instructions 128 using the copy options 130.

By way of example, the UI element 132 may include text that may be displayed to the user via the PLM UI 116, wherein the text may indicate using the copy options 130 for copying one or more sets 122, and wherein the text may include “copy,” “copy selected sets,” “branch,” “branch selected sets,” or the like. In further examples, the UI element 132 may optionally indicate one or more of the copy options 130, e.g., to provide transparency to the user and allow the user to amend the copy options 130 if required.

In further examples, the application software component 106 and/or the processor 102 may further be configured to receive second user input 134 indicative of a selection of the UI element 132 with respect to at least one second subset 126′ of the plurality of sets 122.

In some examples, the received copy options 130 as well as the corresponding computer instructions 128 and the UI element 132 may be used or reused by a user of the PLM system 118 to copy the respective second subset 126′. Hence, while the copy options 130 may have been provided by the user in the context of the desired copy of the respective first subset 126, the same copy options 130 as well as the corresponding computer instructions 128 and the UI element 132 may be used or reused for another copy or branch action involving the respective second subset 126′, which may at least in part be different from the first subset 126.

For the mentioned use or reuse of the received copy options 130 as well as the corresponding computer instructions 128 and the UI element 132 with respect to the respective second subset 126′, the user of the PLM system 118 may provide the second user input 134. The second user input 134 may involve the user selecting, activating, or clicking on the UI element 132. By way of example, the second user input 132 may further indicate which of the plurality of sets 122 are of interest to the user and accordingly form the respective second subset 126′. In some examples, the selection of the respective second subset 126′ may be done by the user beforehand, e.g., before selecting, activating, or clicking on the UI element 132. The respective second subset 126′ may include only a part and not all of the plurality of sets 122 and may or may not have sets 122 in common with the respective first subset 126. In further examples, the user of the PLM system 118 may provide the second user input 134 in natural language, e.g., in text form using a keyboard as the input device 110 and using an input text box of the PLM UI 116, wherein oral input may also be possible, e.g., using a microphone as the input device 110.

By way of example, the application software component 106 and/or the processor 102 may further be configured to store a copy of the respective second subset 126′ using the computer instructions 128.

The computer instructions 128 may be executed, e.g., by the processor 102, to copy the respective second subset 126′ using the copy options 130. The created copy of the respective second subset 126′ may then be stored, e.g., by the processor 102, at a suitable data storage location. As already mentioned above, the created duplicate of the respective second subset 126′ may be different from the original respective second subset 126′ since the copy options 130 may imply making certain amendments to the original respective second subset 126′ to obtain the copied version of the respective second subset 126′.

In further examples, the stored copy of the respective second subset 126′ may be displayed to the user via the PLM UI 116.

The received copy options 130 as well as the corresponding computer instructions 128 and the UI element 132 may be reused by the user of the PLM system 118 as often as useful and desired, e.g., for as many of the sets 122 or second subsets 126′ as desired by the user, thereby facilitating an automated bulk branching of sets 122 of artifact information. As mentioned above, the copy options 130 may have originally been provided by the user in the context of the desired copy of the respective first subset 126 thus, e.g., enabling the user to test and verify the copy options 130 by copying the respective first subset 126 before reusing the copy options 130, the corresponding computer instructions 128, and the UI element 132 for copying one or more second subsets 126′.

By way of example, the plurality of sets 122, the first user input 124 including an indication of the copy options 130, and/or second user input 134 including an indication of the selection of the UI element 132 may be provided and stored in the data store 108 of the PLM system 118, e.g., by the user using the PLM UI 116 and/or the input device 110. In some examples, the plurality of sets 122, the first user input 124 including an indication of the copy options 130, and/or second user input 134 including an indication of the selection of the UI element 132 may be received, e.g., via an API, from another data source 108′ or from the internet.

In further examples, the one or more first subsets 126 and/or the one or more second subsets 126′ may be included in an artifact information document 148. In some examples, copying the respective first subset 126 and/or copying the respective second subset 126′ may include copying the artifact information document 148 including the respective first subset 126 and/or copying the respective second subset 126′. In the context of requirements engineering, the one or more first subsets 126 and/or the one or more second subsets 126′ may further or alternatively be included in a development project 150 or a certain space 152 within a given project 150, wherein the respective space 152 may be subordinate to respective project 150, and wherein the project 150 may relate to the development of the physical or software product. In some examples, copying the respective first subset 126 and/or copying the respective second subset 126′ may include copying the project 150 or the space 152 including the respective first subset 126 and/or copying the respective second subset 126′.

In some examples, the copy options 130 may include a target location 138 of the respective set 122.

The target location 138 may be a data store which is different from the data store 108 of the PLM system 118, wherein in other examples, the target location 138 may coincide with the data store 108 of the PLM system 118. Further, the target location 138 may indicate or include a specific uniform resource locator (URL) or uniform resource identifier (URI), e.g., for a web resource. In further examples, the target location 138 may indicate a certain folder, wherein, e.g., in the context of requirements engineering, the target location 138 may indicate the above-mentioned development project 150 or space 152 within the project 150. By way of example, the target location 138 may coincide with the corresponding source location at which the set 122 to be copied is available or stored. Hence, both the source location and the target location 138 may indicate the same artifact information document 148, the same project 150, or the same space 152 included in the same project 150. Herein, in some examples, the set 122 to be copied may be overwritten with the duplicate of the set 122, wherein the duplicate may differ from the original set 122 if defined so in the copy options 130. In further examples, the source location on the target location 138 may differ so that the set 122 to be copied is copied to a different artifact document 148, a different project 150, or a different space 152.

The target location 138 may be provided by the user through the first user input 126 since the first user input 126 may include the copy options 130 that may include the target location 138. Further, the target location 138 may be used for copying the respective second subset 126′ and optionally for copying the respective first subset 126. Hence, the respective set 122 for which the target location 138 may be provided may correspond to the respective second subset 126′ and optionally the respective first subset 126.

By way of example, the copy options 130 may include a respective prefix 140 or suffix 140′ of the respective set 122.

As mentioned above, the created duplicate of the given set 122 may be different from the original given set 122 since the copy options 130 may imply making certain amendments to the original given set 122 to obtain the copied version of the given set 122. The prefix 140 or the suffix 140′ may be one example of an amended duplicate of the given set 122 to be copied. The prefix 140 or the suffix 140′ may be added to the name of the respective copied set 122. In further examples, an already existing prefix 140 or suffix 140′ of the respective set 122 to be copied may be amended for the respective, copied set 122.

By way of example, the name of the user of the PLM system 118, the name of a new project 150, the date of the copied action, or text such as “new” or the like may be used as prefix 140 or suffix 140′. Hence, the second subset 126′ with the name “artifact_XZY” may be copied, wherein the copied second subset 126′ may have the name “branched_artifact_XZY,” “artifact_XZY_customer-project-A,” “artifact_XZY_Oct-27-2024,” or the like.

In some examples, the respective prefix 140 or suffix 140′ may be amended for a bulk of copied sets 122. Further, amending the name of the respective set 122 to be copied may be advisable if the target location 138 of the respective copied set 122 coincides with the source location of the original respective set 122, e.g., the data store 108. Including the respective prefix 140 or suffix 140′ in the copy options 130 may facilitate an automated bulk branching of sets 122 of artifact information. In further examples, the respective prefix 140 or suffix 140′ may be available by default, e.g., in form of a pre-configured copy option 130.

Further, the respective prefix 140 or suffix 140′ may be used for copying the respective second subset 126′ and optionally for copying the respective first subset 126. Hence, the respective set 122 for which the respective prefix 140 or suffix 140′ may be provided may correspond to the respective second subset 126′ and optionally the respective first subset 126.

In further examples, the copy options 130 may include one or more selection criteria 142 of the respective set 122.

The respective selection criterion 142 may be used to select certain sets 122 of interest among the plurality of sets 122 so that the respective selection criterion 142 may be understood as a filter to filter out the interesting sets 122 in a large quantity of available sets 122. The selection criteria 142 may include the name of the user creating or last amending the respective set 122, the date of creation or the last amendment of the respective set 122, the name of the respective set 122, the importance of the respective set 122, the status of the respective set 122, or other data or metadata relating to the respective set 122. Further, the importance of the respective set 122 may include several importance levels, and the status of the respective set 122 may include the statuses “draft,” “initial,” “approved,” or the like.

In some examples, the respective selection criterion 142 may be applied to sets 122 that are included in one or more artifact information documents 148, wherein optionally the respective selection criterion 142 may be applied to one, several, or all of the artifact information documents 148 including the sets 122. The respective selection criterion 142 may allow for project-based filtering, e.g., by filtering users based on the context of the artifact information project 150 or the like. Project-based filtering may provide that users may only search and select individuals from the project 150 the user is working on, and the corresponding sets 122 created or amended by these users. Furthermore, the respective selection criterion 142 may support an efficient multi-selection by searching with a suitable selection criterion and copying only relevant sets 122 in an easy and convenient manner.

As for other copy options 130, the respective selection criterion 142 may be used for copying the respective second subset 126′ and optionally for copying the respective first subset 126. Hence, the respective set 122 for which the respective selection criterion 142 may be provided may correspond to the respective second subset 126′ and optionally the respective first subset 126.

In some examples, the copy options 130 may include an initialization 144 of the respective set 122.

The respective set 122 may include information that may be arranged in fields, such as an assignee of the respective set 122, a time spent working on the respective set 122, an importance or a status of the respective set 122, or the like. Herein, an assignee may be a user who may need to perform certain tasks with the respective set 122.

Including the initialization 144 of the respective set 122 in the copy options 130 may allow to copy and initialize the respective set 122 in one go and may contribute to facilitate an automated bulk branching of sets 122 of artifact information. One or more fields of the respective set 122 may be initialized by default, e.g., the status field: the original set 122 with the status “approved” may be copied, wherein the copied set 122 may only have the status “draft” or “initial” but not yet “approved,” e.g., since an approval in the context of the copied set 122, e.g., a new project 150, is still pending while the project 150 of the original set 122 has already been approved. In further examples, the user may approve the status of one or more artifact information documents 148, wherein the respective, copied artifact information document 148, and/or the respective set 122 may be initialized as described.

As for other copy options 130, the initialization 144 may be used for copying the respective second subset 126′ and optionally for copying the respective first subset 126. Hence, the respective set 122 for which the initialization 144 may be provided may correspond to the respective second subset 126′ and optionally the respective first subset 126.

By way of example, the copy options 130 may include a status information 146 of the respective set 122.

The status information 146 may include one of the above-mentioned statuses of the respective set 122, e.g., including “draft,” “initial,” “approved,” or the like. In some examples, the status information 146 of the respective set 122 may include information on when or by who the status of the respective set 122 has been approved, e.g., using a time stamp or a username or a user role. Furthermore, the status information 146 of the respective set 122 may include an electronic signature of the user approving the status of the respective set 122, optionally including a time stamp in the electronic signature. Hence, the status information 146 may contribute to increase the traceability of the respective set 122 by providing information or evidence on who did what when.

In some examples, the status information 146 of the original, respective set 122 may be copied if no changes are made to the respective set 122. This may particularly imply that one or more sets 122 of an artifact information document 148 are copied, and that the status information 146 refers to the artifact information document 148 or all sets 122 included in the artifact information document 148. In further examples, the several original sets 122 are included by a plurality of artifact information documents 148, wherein the status information 146 of the original, respective set 122 of the bulk of artifact information documents 148 may be copied if no changes are made to the respective set 122 or the bulk of artifact information documents 148.

As for other copy options 130, the status information 146 may be used for copying the respective second subset 126′ and optionally for copying the respective first subset 126. Hence, the respective set 122 for which the status information 146 may be provided may correspond to the respective second subset 126′ and optionally the respective first subset 126.

By way of example, only one of the described copy options 130 may be used for copying the respective second subset 126′, wherein in some examples, several or all of the described copy options 130 may be used for copying the respective second subset 126′.

The application software component 106 and/or the processor 102 may carry out an analogous method of managing lifecycle information, such as automated bulk branching, in a product system 100. Also, the explained examples may be combined to obtain a more detailed method of managing lifecycle information, such as automated bulk branching. Further, a computer-readable medium 160, which may include a computer program product 162, is shown in FIG. 1, wherein the computer program product 162 may be encoded with executable instructions that, when executed, cause the product system 100 or and/or the PLM system 118 to carry out the described method.

Among the advantages of the suggested method is that the suggested approach may facilitate and speed up bulk branching of sets 122 of artifact information. In some examples, bulk branching was not yet possible before, e.g., for connected sets 122 or artifact information documents 148, e.g., including cross-links and cross-references between sets 122 that need to be preserved. In such examples, the suggested approach even enables bulk branching of sets 122 of artifact information. Thanks to the suggested approach, bulk branching may become less tedious and less error-prone and it may be accessible for non-expert users. Further, developing much more complex physical or software products may become easier as collaboration of many developers and product owners working parallelly and simultaneously may be facilitated by facilitating and speeding up bulk branching of sets 122 of artifact information. Further, only those sets 122 may be copied that are relevant to the user or the development project 150 at hand, wherein the relevance may be fixed using the copy options 130. Hence, the suggested approach is slim, resource-efficient with respect to computing and memory resources, and fast. For the user, the suggested approach may allow to branch multiple artifact information documents 148 in one swift action, streamlining the reuse workflow using the copy options 130, the corresponding computer instructions 128 and the UI element 132 with precision and convenience.

By way of example, the suggested approach may allow for quickly and effortlessly creating branches or copies of multiple artifact information documents 148 while maintaining relative links, providing a seamless transition in the development process of a physical or software product. The copied documents 148 or sets 122 may intelligently be linked to their source documents 148 or sets 122, e.g., via the “branched from” field, preserving the connection between them, enabling efficient tracking and management.

Furthermore, the suggested approach offers a simplified workflow for branching: (1) branch multiple documents or sets at once by performing bulk branching in a single act, minimizing repetitive actions, and saving time; (2) customization by defining a common target project, space, naming pattern, and filtering for all documents or tailor these parameters for each document or set individually; (3) set or document overwrite by optionally overwriting a referenced set or document in reused documents or sets to align them with the present development needs; (4) preserve relative links by maintaining the integrity of relative links between a plurality of reused documents or sets while overwriting sets; (5) workflow and signatures by choosing whether to copy or reset workflow and signatures per the project requirements; (6) work item fields by defining which fields of a set should be reset upon reuse, providing complete control over the branching process; and/or (7) JavaScript creation by quickly generating JavaScript that opens the branch dialog with predefined settings for a plurality of documents or sets which a user may frequently branch, improving the user's workflow efficiency.

With the suggested enhanced bulk branching, the user is empowered to branch multiple documents or sets effortlessly, to efficiently manage project development, and to harness the full potential of the reuse and parallel development capabilities.

Furthermore, the suggested approach may particularly be suitable for advanced enterprise customers with comprehensive sets 122 of artifact information or artifact information documents 148.

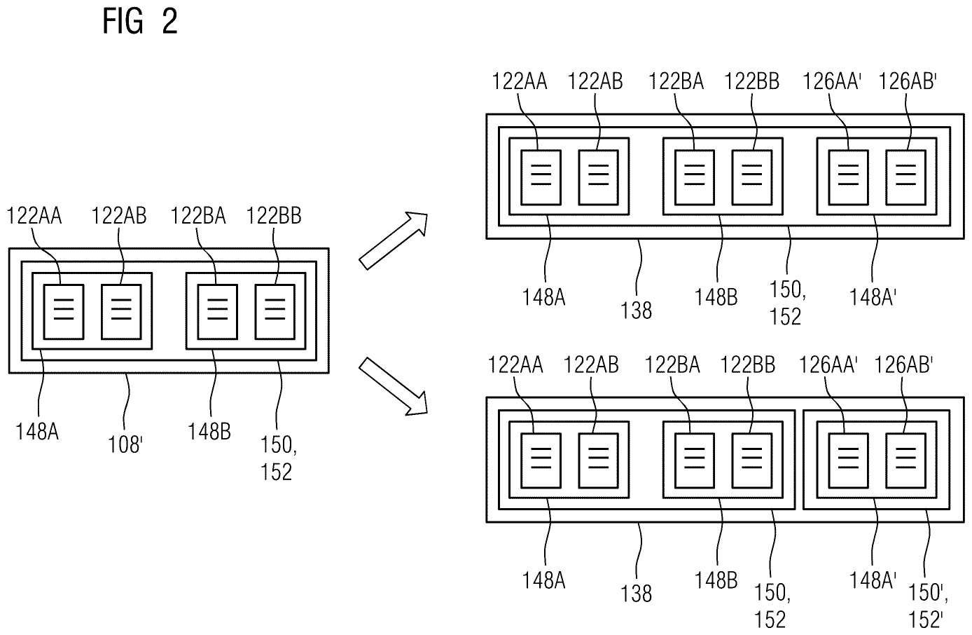

FIG. 2 depicts two aspects relating to the facilitated management of lifecycle information, such as automated bulk branching, in a product system 100.

As depicted on the left side of FIG. 2, a plurality of sets 122 of artifact information may be arranged in the artifact information documents 148 belonging to the artifact information project 150 or an artifact information space 152. Herein, the two sets 122AA and 122AB are included in the first artifact information document 148A, and two sets 122BA and 122BB are included in the second artifact information document 148B, wherein the two artifact information documents 148A and 148B are included in the artifact information project 150 or the artifact information space 152. By way of example, there may be several artifact information spaces 152 including several artifact information documents 148, wherein the artifact information spaces 152 may be included in one artifact information project 150.

Some of the depicted and described sets 122 may be copied using the suggested approach, wherein two alternatives are depicted in FIG. 2. The sets 122 selected for copying then correspond to the second subset 126′. On the upper right of FIG. 2, the first artifact information document 148A including the two sets 122AA and 122AB is copied and stored in the same artifact information project 150 or the same artifact information space 152, wherein the copied artifact information document has the reference sign 148A′, and the copied sets included in the copied artifact information document 148A′ have the reference signs 126AA′ and 126AB′ thus forming the second subset 126′. On the lower right of FIG. 2, the first artifact information document 148A including the two sets 122AA and 122AB is copied and stored in a different artifact information project 150′ or a different artifact information space 152′, wherein the different artifact information project 150′ or the different artifact information space 152′ may be created in the course of the copy action or may already have existed before the copy action. The copied artifact information document has the reference sign 148A′ and is included in the different artifact information project 150′ or the different artifact information space 152′, and the copied sets included in the copied artifact information document 148A′ have the reference signs 126AA′ and 126AB′ thus forming the second subset 126′.

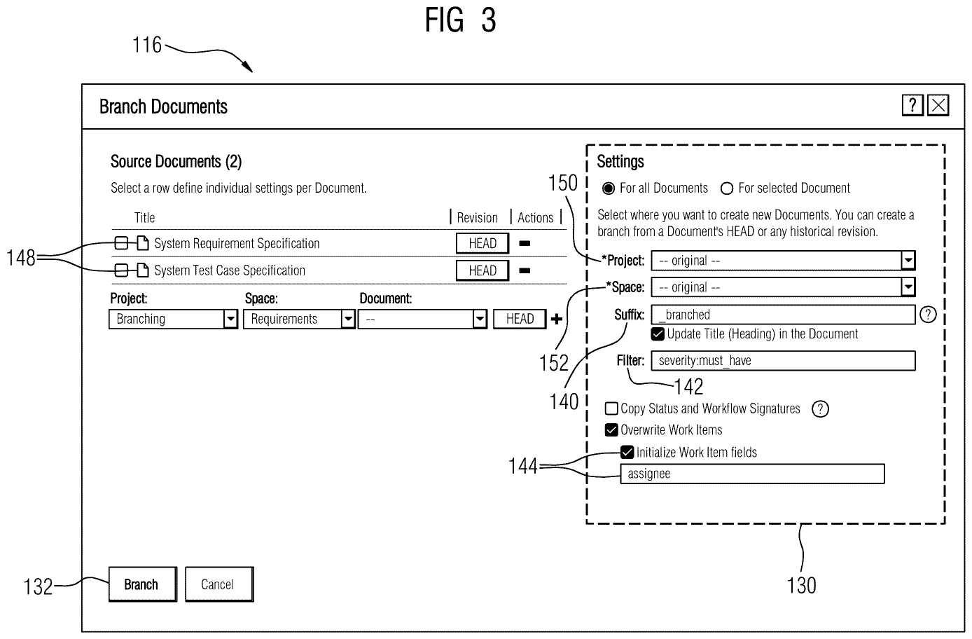

FIG. 3 depicts a first example product lifecycle management UI 116 relating to the facilitated management of lifecycle information, such as automated bulk branching, in a product system 100.

In the PLM UI 116, the user of the PLM system 118 may indicate which artifact information documents 148 are of interest for branching or copying. Accordingly, the sets 122 of artifact information included in the selected artifact information documents 148 may be copied. Further, the user may indicate several copy options 130 which may be applied for the copy action, such as selecting sets 122 from a specific artifact information project 150, selecting sets 122 from a specific artifact information space 152, assigning a specific suffix 140′ to the respective, copied set 122, selecting sets 122 with the selection criteria 142 “severity: must_have” relating to an importance of the respective set 122, and using an initialization 142 of the field “assignee” of the copied set 122. The user may click on the UI element 132 with the text “Branch” to trigger the PLM system 118 to execute the specified copy action using the suggested approach.

In some examples, the scenario depicted in FIG. 3 may correspond to the provision of the copy options 130 by the user in the context of the desired copy of the respective first subset 126 and involving the first user input 124. In further examples, the scenario depicted in FIG. 3 may correspond to the use or reuse of already determined copy options 130 as well as the corresponding computer instructions 128 and the UI element 132 for another copy or branch action involving the respective second subset 126′ which may at least in part be different from the first subset 126.

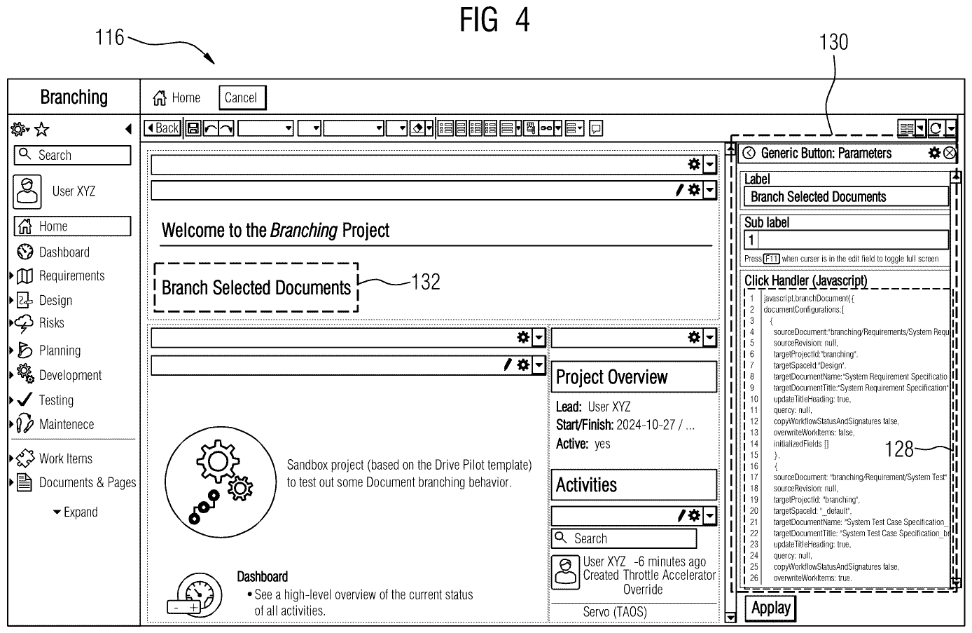

FIG. 4 depicts a second example product lifecycle management UI 116 relating to the facilitated management of lifecycle information, such as automated bulk branching, in a product system 100.

The PLM UI 116 depicted in FIG. 4 may be used by the user of the PLM system to use or reuse already determined copy options 130 as well as the corresponding computer instructions 128 and the UI element 132 for a copy or branch action involving the respective second subset 126′ which may at least in part be different from the first subset 126. The user may benefit from the already defined copy options 130 by simply clicking on the UI element 132 with the text “Branch Selected Document” which triggers the PLM system 118 to copy the corresponding sets 122 included in the selected artifact information documents 148 and complying with the copy options 130. The copy options 130 may be displayed to the user for transparency reasons or if the user desires the copy options 130 to be displayed in the PLM UI 116. Herein, the displayed copy options 130 are included in the computer instruction 128 involving a corresponding JavaScript.

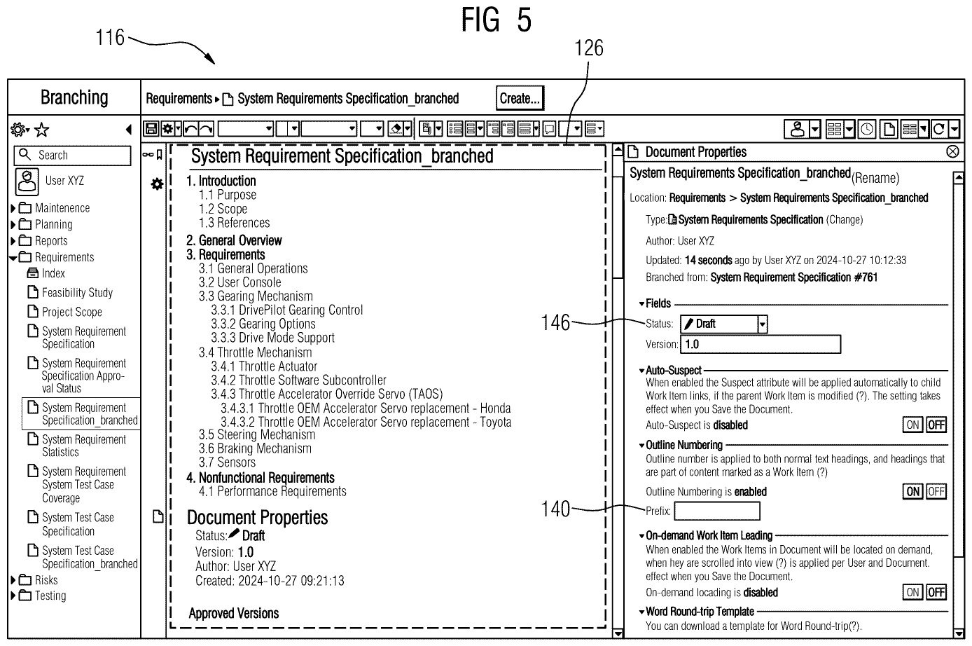

FIG. 5 depicts a third example product lifecycle management UI 116 relating to the facilitated management of lifecycle information, such as automated bulk branching, in a product system 100.

In the PLM UI 116, a copied set 126 and the properties of the copied set 126 are displayed, wherein some of the properties may have been defined as copy options 130 for creating the copied set 126, such as the status information 146 “Draft” or a prefix 140 of the copied set 126. In the example depicted in FIG. 5, the user has decided not to make use of the definition of a prefix 140 as the field of the prefix 140 is empty.

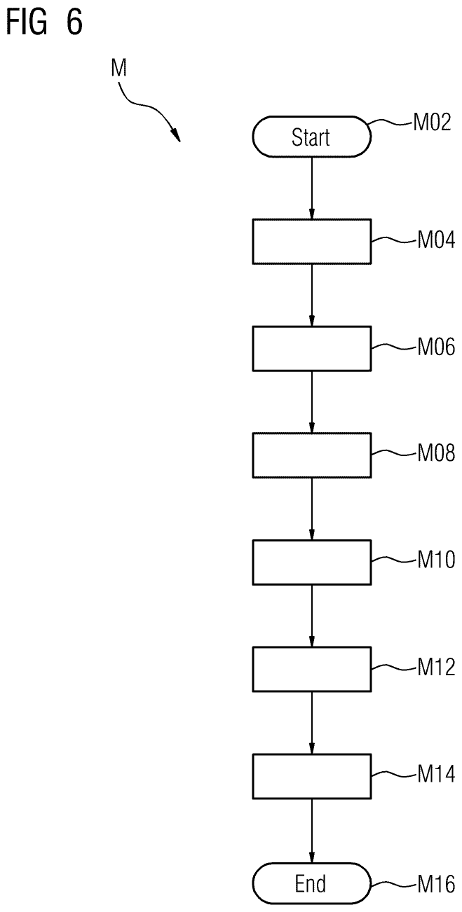

FIG. 6 depicts a flow diagram of an example methodology that facilitates managing lifecycle information, such as automated bulk branching, in a product system. The method may start at M02, and the methodology may include several acts carried out through operation of at least one processor.

These acts may include: act M04 of providing a plurality of sets of lifecycle information; act M06 of receiving first user input indicative of copying at least one first subset of the plurality of sets using copy options; act M08 of generating computer instructions for copying one or more sets of lifecycle information using the copy options; act M10 of displaying a user interface (UI) element in a lifecycle information management UI to a user, wherein the UI element is indicative of a use of the copy options according to the computer instructions; act M12 of receiving second user input indicative of a selection of the UI element with respect to at least one second subset of the plurality of sets; and act M14 of storing a copy of the respective second subset using the computer instructions. At M16, the methodology may end.

The methodology M may include other acts and features discussed previously with respect to the computer-implemented method of managing lifecycle information, such as automated bulk branching, in a product system.

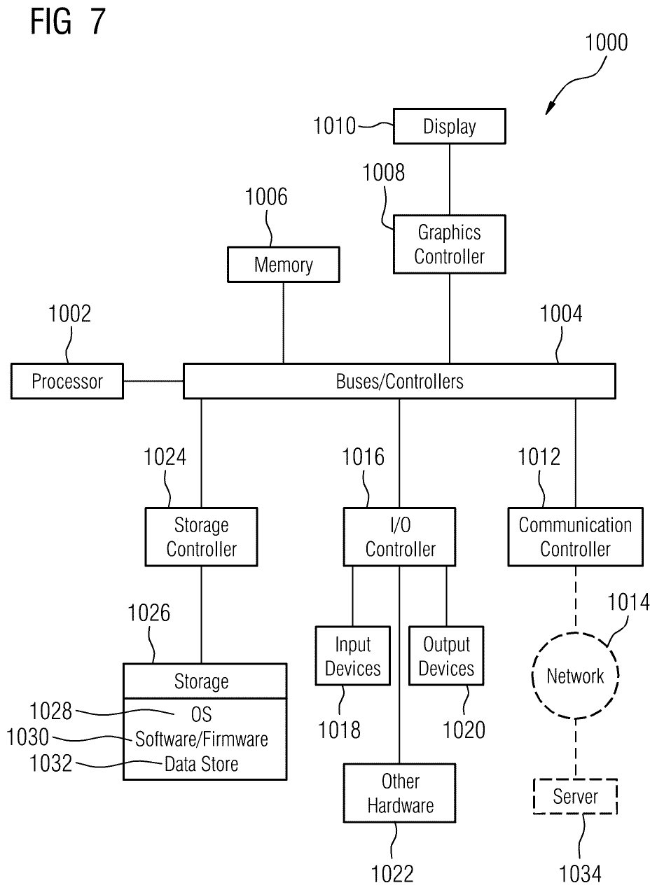

FIG. 7 depicts a block diagram of a data processing system 1000 (also referred to as a computer system) in which an embodiment may be implemented, for example, as a portion of a product system, and/or other system operatively configured by software or otherwise to perform the processes as described herein. The data processing system 1000 may comprise the computer or IT system or data processing system 100 mentioned above. The data processing system depicted comprises at least one processor 1002 (e.g., a CPU) that may be connected to one or more bridges/controllers/buses 1004 (e.g., a north bridge, a south bridge). One of the buses 1004, for example, may comprise one or more I/O buses such as a PCI Express bus. Also connected to various buses in the depicted example may comprise a main memory 1006 (RAM) and a graphics controller 1008. The graphics controller 1008 may be connected to one or more display devices 1010. In some embodiments, one or more controllers (e.g., graphics, south bridge) may be integrated with the CPU (on the same chip or die). Examples of CPU architectures comprise IA-32, x86-64, and ARM processor architectures.

Other peripherals connected to one or more buses may comprise communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may comprise one or more I/O controllers 1016 such as USB controllers, Bluetooth controllers, and/or dedicated audio controllers (connected to speakers and/or microphones). Various peripherals may be connected to the I/O controller(s) (via various ports and connections) comprising input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, devices referred to as input devices or output devices may both provide inputs and receive outputs of communications with the data processing system. For example, the processor 1002 may be integrated into a housing (such as a tablet) that comprises a touch screen that serves as both an input and display device. Further, some input devices (such as a laptop) may comprise a plurality of different types of input devices (e.g., touch screen, touch pad, keyboard). Also, other peripheral hardware 1022 connected to the I/O controllers 1016 may comprise any type of device, machine, or component that is configured to communicate with a data processing system.

Additional components connected to various busses may comprise one or more storage controllers 1024 (e.g., SATA). A storage controller may be connected to a storage device 1026 such as one or more storage drives and/or any associated removable media, which may be any suitable non-transitory machine usable or machine-readable storage medium. Examples comprise nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may comprise an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may comprise Microsoft Windows™, Linux™, UNIX™, iOS™, or Android™ operating systems. Also, examples of data stores comprise data files, data tables, relational database (e.g., Oracle™, Microsoft™ SQL Server), database servers, or any other structure and/or device that is capable of storing data, which is retrievable by a processor.

The communication controllers 1012 may be connected to the network 1014 (not a part of data processing system 1000), which may be any public or private data processing system network or combination of networks, as known to those of skill in the art, comprising the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” may refer to any device, system, or part thereof that controls at least one operation, whether such a device is implemented in hardware, firmware, software, or some combination of at least two of the same. The functionality associated with any particular controller may be centralized or distributed, whether locally or remotely.

In addition, data processing systems may be implemented as virtual machines in a virtual machine architecture or cloud environment. For example, the processor 1002 and associated components may correspond to a virtual machine executing in a virtual machine environment of one or more servers. Examples of virtual machine architectures comprise VMware ESCi, Microsoft Hyper-V, Xen, or KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, the processor described herein may be located in a server that is remote from the display and input devices described herein. In such an example, the described display device and input device may be comprised in a client device that communicates with the server (and/or a virtual machine executing on the server) through a wired or wireless network (which may comprise the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols comprise Teradici's PCoIP, Microsoft's RDP, or the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, the words or phrases used herein should be construed broadly, unless expressly limited in some examples. For example, the terms “comprise” and “comprise,” as well as derivatives thereof, mean inclusion without limitation. The singular forms “a,” “an,” and “the” are intended to comprise the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first,” “second,” “third,” and so forth may be used herein to describe various elements, functions, or acts, these elements, functions, or acts should not be limited by these terms. Rather these numeral adjectives are used to distinguish different elements, functions or acts from each other. For example, a first element, function, or act may be termed a second element, function, or act, and, similarly, a second element, function, or act may be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. Further, a processor that is “configured to” carry out one or more functions or processes may also correspond to a processor circuit particularly fabricated or “wired” to carry out the functions or processes (e.g., an ASIC or FPGA design). Further, the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean that an element is relatively near to but not in contact with a further element, or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element, which must be included in the claim scope. Instead, the scope of patented subject matter is defined only by the allowed claims.

### LIST OF REFERENCE SIGNS

100 processing system
102 processor
104 memory
106 application software component
108 internal data store
110 input device
112 display device
114 graphical user interface (GUI)
116 product lifecycle management UI
118 product lifecycle management system
122 (plurality of) set(s)
124 first user input
126 first subset
126′ second subset
128 computer instructions
130 copy options
132 UI element
134 second user input
136 copied subset
138 target location
140 prefix
140′ suffix
142 selection criteria
144 initialization
146 status information
148 artifact information document
150 artifact information project
152 artifact information space
160 computer-readable medium
162 computer program product

1. A computer-implemented method of managing lifecycle information, the method comprising:
providing a plurality of sets of lifecycle information;
receiving a first user input indicative of copying at least one first subset of the plurality of sets using copy options;
generating computer instructions for copying one or more sets of the plurality of sets using the copy options;
displaying a user interface (UI) element in a lifecycle information management UI to a user, wherein the UI element is indicative of a use of the copy options according to the computer instructions;
receiving a second user input indicative of a selection of the UI element with respect to at least one second subset of the plurality of sets; and
storing a copy of the respective second subset using the computer instructions.

2. The computer-implemented method of claim 1, wherein the copy options comprise a target location of the respective set of the plurality of sets.

3. The computer-implemented method of claim 1, wherein the copy options comprise a respective prefix or suffix of the respective set of the plurality of sets.

4. The computer-implemented method of claim 1, wherein the copy options comprise one or more selection criteria of the respective set of the plurality of sets.

5. The computer-implemented method of claim 1, wherein the copy options comprise an initialization of the respective set of the plurality of sets.

6. The computer-implemented method of claim 1, wherein the copy options comprise a status information of the respective set of the plurality of sets.

7. A computer system comprising:
at least one processor and at least one memory configured to:
provide a plurality of sets of lifecycle information;
receive a first user input indicative of copying at least one first subset of the plurality of sets using copy options;
generate computer instructions for copying one or more sets of the plurality of sets using the copy options;
display a user interface (UI) element in a lifecycle information management UI to a user, wherein the UI element is indicative of a use of the copy options according to the computer instructions;
receive a second user input indicative of a selection of the UI element with respect to at least one second subset of the plurality of sets; and
store a copy of the respective second subset using the computer instructions.

8. A computer program product or a computer-readable medium comprising the computer program product, wherein the computer program product comprises computer program code that, when executed by a computer system, causes the computer system to:
provide a plurality of sets of lifecycle information;
receive a first user input indicative of copying at least one first subset of the plurality of sets using copy options;
generate computer instructions for copying one or more sets of the plurality of sets using the copy options;
display a user interface (UI) element in a lifecycle information management UI to a user, wherein the UI element is indicative of a use of the copy options according to the computer instructions;
receive a second user input indicative of a selection of the UI element with respect to at least one second subset of the plurality of sets; and
store a copy of the respective second subset using the computer instructions.
